(19) United States
(12) Patent Application Publication
(10) Pub. No.: US 2026/0357141 A1
(43) Pub. Date: Nov. 12, 2026

(54) VISCOSITY REDUCTION OF HYDROTHERMAL LIQUEFACTION BIOCRUDE

(71) Applicant: CIRCLIA NORDIC APS, AARHUS V (DK)

(72) Inventors: IB JOHANNSEN, AARHUS (DK); JULIANO DOS PASSOS, RISSKOV (DK)

(21) Appl. No.: 19/109,208

(22) PCT Filed: Sep. 7, 2023
(86) PCT No.: PCT/DK2023/050218

§ 371 Date: Mar. 6, 2025

(30) Foreign Application Priority Data
Sep. 8, 2022 (DK) PA202200827

(51) Int. Cl. C10G 29/22; C10G 1/00; C10G 1/06; C10G 33/00

(52) U.S. Cl. CPC C10G 29/22; C10G 1/002; C10G 33/00; C10G 1/065; C10G 2300/1011; C10G 2300/202; C10G 2300/302

(57) ABSTRACT

A process for upgrading a hydrothermal liquefaction (HTL) based biocrude (HBC) is disclosed, the process comprising the steps of providing a first stream (FST) comprising the HTL based biocrude (HBC), providing at least one alcohol (ALC), mixing the HTL based biocrude (HBC) and the at least one alcohol (ALC) to provide 5 an alcohol-biocrude mixture (ABM), and subjecting the alcohol-biocrude mixture (ABM) to a processing temperature and a processing pressure to form a viscosity reduced biocrude (VRB) and to separate an evaporated water fraction (EWF), wherein the processing temperature is at least the boiling point of water at the processing pressure, and wherein the at least one alcohol (ALC) has a boiling point which is above 10 said processing temperature. Also, a system and a method of mixing is disclosed.

### FIELD OF INVENTION

The invention relates to a process for upgrading a hydrothermal liquefaction based biocrude according to the claims, a system for upgrading a hydrothermal liquefaction based biocrude according to the claims, and a method of mixing a viscosity reduced biocrude according to the claims.

### BACKGROUND

In recent years, increasing effort is taken to provide new, renewable energy source. One process of interest is hydrothermal liquefaction, which has the benefit of producing a biocrude, i.e. a fuel source which has a quite high degree of compatibility with existing fossil crude oil processing facilities and technology.

However, a significant disadvantage of hydrothermal liquefaction biocrude is a relatively high viscosity in part due to a high acid number, which makes processing at ambient temperatures very difficult or even impossible.

One way of neutralizing acid groups may be esterification, where the highly reactive alcohols of methanol or ethanol are typically added due to their superior esterification conversion and low price. However, remaining alcohols in the processed biocrude may undesirably lower the flashpoint. This may in turn result in significant safety measures for e.g. processing plants or when using directly as a bunker fuel.

Another way of handling the increased viscosity is to provide heated storage and transportation of the biocrude. This lowers the viscosity without the mentioned safety issues, but also result in undesirable energy use for heating and more complicate setup to ensure heating equipment.

It is an object of the invention to solve the above problems.

### SUMMARY

The invention relates to a process for upgrading a hydrothermal liquefaction based biocrude, the process comprising the steps of
providing a first stream comprising the HTL based biocrude,
providing at least one alcohol,
mixing the HTL based biocrude and the at least one alcohol to provide an alcohol-biocrude mixture, and
subjecting the alcohol-biocrude mixture to a processing temperature and a processing pressure to form a viscosity reduced biocrude and to separate an evaporated water fraction,
wherein the processing temperature is at least the boiling point of water at the processing pressure, and
wherein the at least one alcohol has a boiling point which is above said processing temperature.

An advantage of the invention may be that a significant reduction in viscosity may be obtained while at the same time lowering the water content. Due to the utilization of alcohols with a high boiling point, a selective removing water by evaporation may be obtained using a processing temperature the boiling point of water at the processing pressure, while at the same time facilitating an esterification conversion of alcohols and carboxylic acids both due to the applied high processing temperature and the removal of water to shift the equilibrium of the esterification reaction.

Thus, it is of understood in the context of the present invention that the at least one alcohol has a boiling point which is above said processing temperature at said processing pressure.

Furthermore, an advantage of the invention may be that an esterification of at least some carboxylic acid groups of the HTL based biocrude is facilitated. The reaction between carboxylic acid groups and the added at least one alcohol can react by esterification to form an ester. Such resulting ester compounds has significantly lower viscosity compared to the carboxylic acid and the alcohol, whereby the final viscosity reduced biocrude is much more handleable, e.g. in terms of pumpability due to the reduced viscosity. This may in turn reduce or even eliminate any need for heating the biocrude, which otherwise typically may be employed during storage as well as transportation.

An advantage of the invention may be that any residual amount of said at least one alcohol is mainly kept in the viscosity reduced biocrude and only minor amounts of said residual amount of said at least one alcohol is separated as part of the water fraction.

It is further noted that an advantage of the invention may be that the claimed increased processing temperature is applied, as this may significantly increase the reaction speed and thus increase the output of a processing facility.

The step of subjecting the alcohol-biocrude mixture to the claimed processing temperature to separate an evaporated water fraction may be referred to as a processing step.

It is also noted that the pressure in the processing step may be near atmospheric in some embodiments. In some other embodiments, a higher pressure may be applied.

It is noted that while the invention defines that an evaporated water fraction is separated from the alcohol-biocrude mixture, the process may in some embodiments comprise further water separation steps, in particular where water is removed as a liquid from the alcohol-biocrude mixture prior to the separation by evaporation and/or where water is removed as a liquid from the viscosity removed biocrude. In other embodiments, water is only removed as the evaporated water fraction. It is also noted that the removal of the evaporated water fraction may be a one step process e.g. in a single reactor, or may comprise several steps, e.g. in two or more reactors.

It should be understood that the viscosity reduced biocrude is obtained from said alcohol-biocrude mixture after processing with at least the heating and the extracting steps.

The term “alcohol-biocrude mixture” refers to a composition mainly being composed of said at least one alcohol mixed with said HTL based biocrude. In some embodiments, the alcohol-biocrude mixture may contain certain amounts of further components, in particular catalysts, when used.

It is noted that the term “viscosity reduced biocrude” refers to the final product of the process, which has a reduced viscosity compared to the HTL based biocrude. It is noted that the viscosity reduced biocrude may contain a residual content of said at least one alcohol,

According to an advantageous embodiment of the invention, the process further comprises one or more water-separation steps where water is removed in liquid state from the alcohol-biocrude mixture and/or from the viscosity reduced biocrude.

In an embodiment of the invention, the process comprises one or more water-separation steps where water is removed in liquid state from the alcohol-biocrude mixture before the step of subjecting the alcohol-biocrude mixture to the processing temperature.

In an embodiment of the invention, the process comprises one or more water-separation steps where water is removed in liquid state from the viscosity reduced biocrude.

According to an advantageous embodiment of the invention, the processing temperature is at least 5 degrees Celsius above the boiling point of water at the processing pressure, such at least 10 degrees Celsius above the boiling point of water at the processing pressure, such as at least 20 degrees Celsius above the boiling point of water at the processing pressure.

Having a high processing temperature has the advantage of speeding up the esterification reaction both due to advantageous reaction kinetics and due to the facilitation of the removal of water, which aids in shifting the reaction equilibrium towards forming of esters.

According to an advantageous embodiment of the invention, the processing temperature is at least 100 degrees Celsius, such as at least 110 degrees Celsius, such as at least 120 degrees Celsius.

Having a high processing temperature has the advantage of speeding up the esterification reaction both due to advantageous reaction kinetics and due to the facilitation of the removal of water, which aids in shifting the reaction equilibrium towards forming of esters. The above-mentioned temperatures may be especially advantageous when applying atmospheric or near-atmospheric pressure.

In an embodiment of the invention, the processing temperature is within a range of 100 to 250 degrees Celsius, such as within a range of 110 to 220 degrees Celsius, such as within a range of 120 to 180 degrees Celsius.

According to an advantageous embodiment of the invention, the process further comprises heating the alcohol-biocrude mixture during said extracting to maintain the alcohol-biocrude mixture at said processing temperature.

In the present context it should be understood that the alcohol is an organic compound that carries at least one hydroxyl functional group (—OH) bound to a saturated carbon atom. Thus, the alcohol may comprise several carbons arranged to form a linear hydrocarbon chain or a non-linear hydrocarbon chain comprising one or more double and/or triple bonds. Similarly, the alcohol may comprise a simple hydrocarbon chain, or may comprise a more structure, e.g. a split hydrocarbon chain, such as isobutanol. Also, it is noted that said at least one alcohol may be a single alcohol or may be a mixture of two or more alcohols.

Typically, the at least one alcohol may be aliphatic alcohol(s) or predominantly aliphatic alcohol(s).

According to an advantageous embodiment of the invention, the at least one alcohol comprises aliphatic alcohol in an amount of at least 80% by weight of the at least one alcohol, such as at least 90% by weight of the at least one alcohol, such as at least 95% by weight of the at least one alcohol.

According to an advantageous embodiment of the invention, the at least one alcohol comprises aliphatic alcohol having or not in the same said molecule other chemical groups such as ethers, esters, ketones, or ethers, in an amount of at least 80% by weight of the at least one alcohol, such as at least 90% by weight of the at least one alcohol, such as at least 95% by weight of the at least one alcohol.

Thus, it should be understood that the aliphatic alcohol may comprise one or more other chemical group(s) as mentioned or may be free of such other chemical groups.

According to an embodiment of the invention, the at least one alcohol comprises aliphatic alcohol having at least two saturated carbons before other functional groups, such as oxygen, ketones, or ethers, in an amount of at least 80% by weight of the at least one alcohol, such as at least 90% by weight of the at least one alcohol, such as at least 95% by weight of the at least one alcohol.

In an embodiment of the invention, the at least one alcohol comprises aliphatic alcohol in an amount of 80-100% by weight of the at least one alcohol, such as 90-99.9% by weight of the at least one alcohol, such as 95-99% by weight of the at least one alcohol, such as.

In an embodiment of the invention, the at least one alcohol is composed of one or more aliphatic alcohol(s).

According to an advantageous embodiment of the invention, the at least one alcohol has a solubility in water of no more than 100 grams per Liter at 25 degrees Celsius, such as no more than 25 grams per Liter at 25 degrees Celsius, such as no more than 10 grams per Liter at 25 degrees Celsius, such as no more than 5 grams per Liter at 25 degrees Celsius, such as no more than 2 grams per Liter at 25 degrees Celsius.

An advantage of the above embodiment may be that a significant reduction in loss of the alcohol may be obtained. Due to a lower affinity for water, any unreacted alcohol would mainly be found in the oil phase of the HTL based biocrude and the viscosity reduced biocrude. Especially when separating one or more liquid water-based phase(s) from the alcohol-biocrude mixture or the viscosity reduced biocrude, the above embodiment is advantageous due to a low loss of unreacted alcohols in the separated water-based phase(s).

In an embodiment of the invention, the at least one alcohol has a solubility in water within a range of 1 microgram per Liter to 25 grams per Liter at 25 degrees Celsius, such as within a range of 1 microgram per Liter to 25 degrees Celsius, such as within a range of 1 microgram per Liter to 5 grams per Liter at 25 degrees Celsius, such as within a range of 1 microgram per Liter to 2 grams per Liter at 25 degrees Celsius.

It is noted that the term “solubility in water” as used herein refers to solubility in water at a temperature of 25 degrees Celsius, unless otherwise specified.

According to an advantageous embodiment of the invention, the at least one alcohol has a boiling point of at least 110 degrees Celsius, such as at least 120 degrees Celsius.

In an embodiment of the invention, the at least one alcohol has a boiling point of within a range of above 100 to 250 degrees Celsius, such as within 110 to 250 degrees Celsius, such as within 120 to 250 degrees Celsius.

It is noted that the term “boiling point” as used herein refers to the boiling point at atmospheric conditions unless otherwise stated.

According to an advantageous embodiment of the invention, the at least one alcohol is selected from C4 or higher alcohols, such as C6 or higher alcohols, such as C8 or higher alcohols.

In an embodiment of the invention, the at least one alcohol is selected from C4-C18 alcohols, such as C6-C16 alcohols, such as C8-C14 alcohols.

Examples of usable alcohols include butanol, pentanol, hexanol, heptanol, octanol, nonanol, decanol, dodecanol, tetradecanol, hexadecanol, octadecanol, etc., including isomers and/or mixtures thereof. It is noted that the above are only usable to the extent that they have a boiling point above 100 degrees Celsius. In some embodiments, further restrictions are applied, in particular to the solubility in water at 25 degrees Celsius.

According to an advantageous embodiment of the invention, said at least one alcohol is selected from alcohols having a molar mass between 60 and 220 g/mol, such as between 60 and 150 g/mol, such as between 80 and 150 g/mol.

According to an advantageous embodiment of the invention, the ratio between the HTL based biocrude and the at least one alcohol is between 30:1 and 1:1, such as between 10:1 and 1:1, such as 5:1 and 1:1, such as e.g. 2:1 or 1.5:1.

According to an advantageous embodiment of the invention, the amount of the at least one alcohol is at least 3% by weight of the alcohol-biocrude mixture, such as at least 5% by weight of the alcohol-biocrude mixture, such as at least 10% by weight of the alcohol-biocrude mixture, such as at least 20% by weight of the alcohol-biocrude mixture.

In an embodiment of the invention, the amount of the at least one alcohol is 3-50% by weight of the alcohol-biocrude mixture, such as 5-45% by weight of the alcohol-biocrude mixture, such as 10-40% by weight of the alcohol-biocrude mixture.

According to an advantageous embodiment of the invention, the amount of the HTL based biocrude is at least 50% by weight of the alcohol-biocrude mixture, such as at least 60% by weight of the alcohol-biocrude mixture, such as at least 70% by weight of the alcohol-biocrude mixture.

In an embodiment of the invention, the amount of the HTL based biocrude is 50-90% by weight of the alcohol-biocrude mixture, such as 60-85% by weight of the alcohol-biocrude mixture, such as 70-80% by weight of the alcohol-biocrude mixture.

In an embodiment of the invention, the alcohol biocrude mixture has a water content of 0.5 to 15% by weight of the alcohol biocrude mixture, such as 1.0 to 10% by weight of the alcohol biocrude mixture, such as 2 to 8% by weight of the alcohol biocrude mixture.

In alternative embodiments, an untreated alcohol-biocrude mixture has a higher content of water and may therefore advantageously be subjected to an additional water separation step to obtain the above mentioned water content of the alcohol biocrude mixture.

According to an advantageous embodiment of the invention, the at least one alcohol is added to the HTL based biocrude at a pressure of no more than 10 bar, such as no more than 3 bar.

According to an advantageous embodiment of the invention, the at least one alcohol is added to the HTL based biocrude at a pressure of at least 10 bar, such as at least 100 bar.

According to an advantageous embodiment of the invention, the heating of the HTL based biocrude and the at least one alcohol to a processing temperature is subsequent to mixing the HTL based biocrude and the at least one alcohol to an alcohol-biocrude mixture.

According to an advantageous embodiment of the invention, the heating of the HTL based biocrude and the at least one alcohol to a processing temperature is prior to mixing the HTL based biocrude and the at least one alcohol to an alcohol-biocrude mixture.

The mixing may be in a separate mixing unit such as a static mixer, an actively stirred mixer and so on or done directly in a first reactor or reactor unit.

Typically, the mixing process may be relative fast, and have a duration of e.g. 1-500 seconds.

According to an advantageous embodiment of the invention, said alcohol-biocrude mixture is subjected to said processing temperature and processing pressure in a batch mode.

According to an advantageous embodiment of the invention, said alcohol-biocrude mixture is subjected to said processing temperature and processing pressure in a continuous mode.

According to an advantageous embodiment of the invention, said alcohol-biocrude mixture is subjected to said processing temperature and processing pressure in at least one stirred reactor unit.

According to an advantageous embodiment of the invention, said at least one stirred reactor unit is a string of at least two subsequent stirred reactor units, such as at least three subsequent stirred reactor units.

According to an advantageous embodiment of the invention, said stirred reactor unit(s) are operated as continuous stirred-tank reactors.

According to an advantageous embodiment of the invention, said mixing reactors are continues stirred-tank reactors.

According to an advantageous embodiment of the invention, said mixing and heating has a duration of at least 5 minutes, such a at least 15 minutes, such as at least 1 hour.

In an embodiment of the invention, said mixing and heating may have a duration of up to 24 hours.

According to an advantageous embodiment of the invention, the viscosity reduced biocrude has a viscosity that is at least 40% lower than the HTL based biocrude.

According to an advantageous embodiment of the invention, the viscosity reduced biocrude has a viscosity that is at least 10% than the alcohol-biocrude mixture.

As referred to herein, unless otherwise specified, viscosity measurements are done with a Brookfield DVNext viscometer equipped with a 20 mm conical plate, with measurements were taken at 40 degrees Celsius, using 1 s\hat{ }-1 shear rate and 300 μm of gap.

According to an advantageous embodiment of the invention, the viscosity of the HTL based biocrude is at least 9000 mPa*s, such as at least 10000 mPa*s, such at least 12000 mPa*s.

According to an advantageous embodiment of the invention, the viscosity reduced biocrude has a viscosity of no more than 8000 mPa*s, such as no more than 7000 mPa*s.

According to an advantageous embodiment of the invention, the viscosity reduced biocrude has an acid number that is at least 10% lower than the HTL based biocrude, such as at least 20% lower, such as at least 30% lower, such at least 40% lower.

According to an embodiment of the invention, the viscosity reduced biocrude has an acid number that is 10-90% lower than the HTL based biocrude, such as 20-80% lower, such as 30-70% lower, such 40-60% lower.

According to an advantageous embodiment of the invention, the viscosity reduced biocrude has an acid number that is at least 10 mg KOH per kilogram lower than for the HTL based biocrude, such as at least 25 mg KOH per kilogram lower than for the HTL based biocrude, such as at least 40 mg KOH per kilogram lower than for the HTL based biocrude.

According to an embodiment of the invention, the viscosity reduced biocrude has an acid number that is 10-140 mg KOH per kilogram lower than for the HTL based biocrude, such as 25-120 mg KOH per kilogram lower than for the HTL based biocrude, such as 40-100 mg KOH per kilogram lower than for the HTL based biocrude.

According to an advantageous embodiment of the invention, the degree of conversion of said at least one alcohol is at least 2% by weight of said at least one alcohol, such as at least 5% by weight of said at least one alcohol, such as at least 10% by weight of said at least one alcohol, such as at least 20% by weight of said at least one alcohol.

In the present context, the term “hydrothermal liquefaction” refers to a process of decomposition of wet biomass at high temperatures and pressure to produce a HTL biocrude, i.e. a biocrude originating from a hydrothermal liquefaction reaction. The wet biomass is biomass mixed with water, e.g. with a water content of above 50% by weight, such as 50-90% by weight. The wet biomass may also comprise other components, additives etc. The wet biomass, i.e. the input to the hydrothermal liquefaction unit may also be referred to as feedstock. Typically, the applied temperatures during hydrothermal liquefaction range from 250 to 450 degree Celsius, such as 300 to 425 degrees Celsius. Also, the applied pressure during hydrothermal liquefaction ranges from 50 to 400 bar, such as 100 to 300 bar.

According to an advantageous embodiment of the invention, the step of providing the hydrothermal liquefaction based biocrude comprising subjecting an aqueous fraction comprising organic components to hydrothermal liquefaction.

According to an advantageous embodiment of the invention, the hydrothermal liquefaction comprises a solid-liquid separation.

Thus, in this embodiment, the HTL based biocrude has been subjected to solid-liquid separation before the at least one alcohol is added.

According to an advantageous embodiment of the invention, the hydrothermal liquefaction comprises a water-biocrude separation step, and where the at least one alcohol is added prior to the water-biocrude separation step.

An advantage of the above embodiment may be that at least one alcohol facilitates breaking up of undesirable emulsions. Higher alcohols are known for their ability to demulsify complex water emulsions. Thereby, due to emulsion breaking characteristics of the added at least one alcohol, an improved water-biocrude separation step may be obtained. In addition, the alcohol addition may can facilitate the partitioning between biocrude and water. This is in particular relevant when at least one alcohol is added before the water oil separation step in the HTL process

According to an advantageous embodiment of the invention, the HTL based biocrude comprises at least 50% biocrude obtained from a hydrothermal liquefaction reaction, such as at least 75% biocrude obtained from a hydrothermal liquefaction reaction, such as at least 90% biocrude obtained from a hydrothermal liquefaction reaction, such as at least 95% biocrude obtained from a hydrothermal liquefaction reaction, such at least 98% biocrude obtained from a hydrothermal liquefaction reaction.

In an embodiment of the invention, the HTL based biocrude consists of biocrude obtained from a hydrothermal liquefaction reaction.

In embodiments where the HTL based biocrude comprises other components apart from the biocrude obtained from a hydrothermal liquefaction reaction, such other components may include vegetable oil or biodiesel, the content of which may vary e.g. from 2-50% by weight of the HTL based biocrude or below 2% by weight of the HTL based biocrude. Other components may also be present apart from the vegetable oil or biodiesel, or instead of the vegetable oil or biodiesel.

According to an advantageous embodiment of the invention, the HTL based biocrude has an acid number of at least 50 mg KOH per kilogram of HTL based biocrude, such as at least 75 mg KOH per kilogram of HTL based biocrude.

According to an embodiment of the invention, the HTL based biocrude has an acid number of 50-500 mg KOH per kg, such as 75-300 mg KOH per kg.

According to an advantageous embodiment of the invention, the HTL based biocrude has a heating value of at least 25 MJ per kg, such as at least 28 MJ per kg, such as at least 30 MJ per kg.

In an embodiment of the invention, the HTL based biocrude has a heating value of 25-50 MJ per kg, such as 28-50 MJ per kg, such as 30-45 MJ per kg.

According to an advantageous embodiment of the invention, the HTL based biocrude has a carbon content of at least 65% by weight of the HTL based biocrude.

According to an advantageous embodiment of the invention, the HTL based biocrude has an oxygen content of less than 25% by weight of the HTL based biocrude.

It is noted that the formed viscosity reduced biocrude may be mixed with other fuel components and additives such as biodiesel, fuel oil, diesel, kerosene, etc. in order to optimize fuel properties. The viscosity reduced fuel will have the advantage of better compatibility with common fuel applications such as in shipping fuel, and in addition a better miscibility with traditional fossil-based fuels.

The viscosity reduced biocrude may also be subjected to traditional refining processes, such as hydrotreatment, hydrocracking, fractional distillation allowing for production of higher quality fuels with the advantage of the lower viscosity and easier miscibility of the viscosity reduced biocrude.

According to an advantageous embodiment of the invention, the alcohol-biocrude mixture furthermore comprises a catalyst, such as an acid.

In an embodiment, the catalyst may be present in an amount of 50 mg per Liter to 1 gram per Liter. Insofar that any solvent is used, the above amounts ignore such solvent(s).

Particularly, the acid catalyst may be selected from sulfuric acid, para toluene sulphonic acid, and immobilized acid catalyst.

According to an advantageous embodiment of the invention, the viscosity reduced biocrude has a water content of no more than 3%, such as no more than 2%, such as no more than 0.5% by weight of the viscosity reduced biocrude.

According to an advantageous embodiment of the invention, the first stream comprises said HTL based biocrude in an amount of at least 2% by weight of the first stream, such as at least 5% by weight of the first stream, such as at least 15% by weight of the first stream, such as at least 30% by weight of the first stream, such as at least 50% by weight of the first stream.

According to an embodiment of the invention, the first stream comprises said HTL based biocrude in an amount of 2-100% by weight of the first stream, such as 5-98% by weight of the first stream, such as 15-95% by weight of the first stream, such as 30-90% by weight of the first stream, such as 50-80% by weight of the first stream.

According to an advantageous embodiment of the invention, the first stream consists of said HTL based biocrude.

In an embodiment of the invention, the alcohol-biocrude mixture may be subjected to a subsequent water/solids separation step. This subsequent water/solids separation step may be at or below the processing temperature.

According to an advantageous embodiment of the invention, the mixing the HTL based biocrude and the at least one alcohol is performed after depressurization of the HTL based biocrude in the hydrothermal liquefaction process.

Thus, in the above embodiment, the HTL based biocrude is produced in a hydrothermal liquefaction process, which comprises a depressurization step. In the above embodiment, the mixing step is after the depressurization step. The depressurization may be understood as the changing the pressure from an operational pressure of the hydrothermal liquefaction itself, e.g. in the range of 150 to 250 bar, to a pressure at or near atmospheric pressure, e.g. in the range of 0.5 to 10 bar.

According to an embodiment of the invention, the at least one alcohol, i.e. the mixing step, is subsequent to the depressurization step and prior to a three-phase separation of the hydrothermal liquefaction.

According to an advantageous embodiment of the invention, the processing pressure below 10 bar, such as below 7.5 bar, such as below 5 bar.

It is noted that the above embodiment includes pressure that are slightly below normal atmospheric pressure down to 0.5 bar and up pressures of 10 bar.

In an embodiment of the invention, the processing pressure is 0.5 to 10 bar, such as such as 0.75 to 7.5 bar, such as 1 to 5 bar.

According to an advantageous embodiment of the invention, the mixing the HTL based biocrude and the at least one alcohol is performed prior to depressurization of the HTL based biocrude in the hydrothermal liquefaction process.

Thus, in the above embodiment, the HTL based biocrude is produced in a hydrothermal liquefaction process, which comprises a depressurization step. In the above embodiment, the mixing step is prior to the depressurization step.

According to an advantageous embodiment of the invention, the processing pressure is at least 150 bar, such as at least 175 bar.

In an embodiment of the invention, the processing pressure is 150 to 250 bar, such as 175 to 225 bar, such as about 200 bar.

The invention further relates to a system for upgrading a hydrothermal liquefaction based biocrude, the system
a first inlet for receiving a first stream comprising the HTL based biocrude,
a second inlet for receiving at least one alcohol,
at least one mixing reactor arranged to mix the HTL based biocrude and the at least one alcohol to provide an alcohol-biocrude mixture, and
at least one processing reactor arranged to receive the alcohol-biocrude mixture and subject the alcohol-biocrude mixture to a processing temperature and a processing pressure to form a viscosity reduced biocrude and to separate an evaporated water fraction,
wherein the processing temperature is at least the boiling point of water at the processing pressure, and
wherein the at least one alcohol has a boiling point which is above said processing temperature.

According to an advantageous embodiment of the invention, the mixing reactor and the processing reactor are integrated as one mixing and processing reactor.

According to an advantageous embodiment of the invention, the mixing reactor and the at least one processing reactor are separate reactors.

The invention further relates to a system according to the invention or any of its embodiments, wherein the system is configured to operate in accordance with the process of the invention or any of its embodiments.

The invention further relates to a method of mixing a viscosity reduced biocrude, the method comprising the steps of
providing a viscosity reduced biocrude according to the invention or any of its embodiments or using the system according to the invention or any of its embodiments, mixing the viscosity reduced biocrude with at least one further combustible component.

According to an advantageous embodiment of the invention, the at least one further combustible component is selected from the list consisting of biodiesel, fuel oil, diesel, kerosene, and any combinations thereof.

### FIGURES

The invention will now be described with reference to the figures, where

FIG. 1 illustrates a process for upgrading a hydrothermal liquefaction HTL based biocrude HBC according to an embodiment of the invention,

FIG. 2 illustrates a process for upgrading a hydrothermal liquefaction HTL based biocrude HBC according to an embodiment of the invention, and

FIG. 3 illustrates a process for upgrading a hydrothermal liquefaction HTL based biocrude HBC according to an embodiment of the invention.

### DETAILED DESCRIPTION

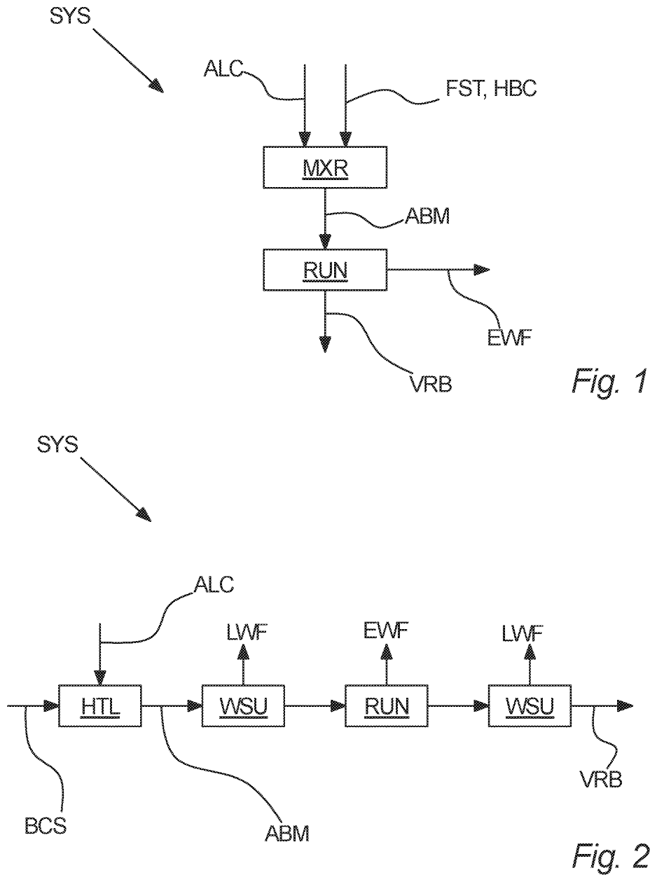

Referring to FIG. 1, a process for upgrading a hydrothermal liquefaction HTL based biocrude HBC according to an embodiment is illustrated.

First, a first stream FST is provided, which comprises the HTL based biocrude HBC. It is noted that in some embodiments, the first stream FST may essentially or completely consist of the HTL based biocrude HBC. In other embodiments, e.g. as illustrated in FIG. 2, the first stream FST may be a stream in e.g. a hydrothermal liquefaction process, i.e. a stream which may mainly consist of water and which in addition thereto contains the HTL based biocrude HBC.

Also, at least one alcohol ALC is provided. In some embodiments the at least one alcohol is provided as part of a second stream, which may comprise additional elements further to the at least one alcohol ALC or may consist of the at least one alcohol ALC.

Then, the at least one alcohol ALC and the HTL based biocrude HBC is mixed, e.g. in a suitable mixing unit MXR. The resulting mixture, also referred to as an alcohol biocrude mixture ABM, is inputted to a reactor unit RUN where it is subjected to a processing temperature and a processing pressure. The processing temperature is at least the boiling point of water at the applied processing pressure. In principle, the reactor unit RUN and the mixing unit MXR may be an integrated unit, but separate units may typically be used. Reactor units such as continuously stirred tank reactor (CSTR) is one type of suitable reactor.

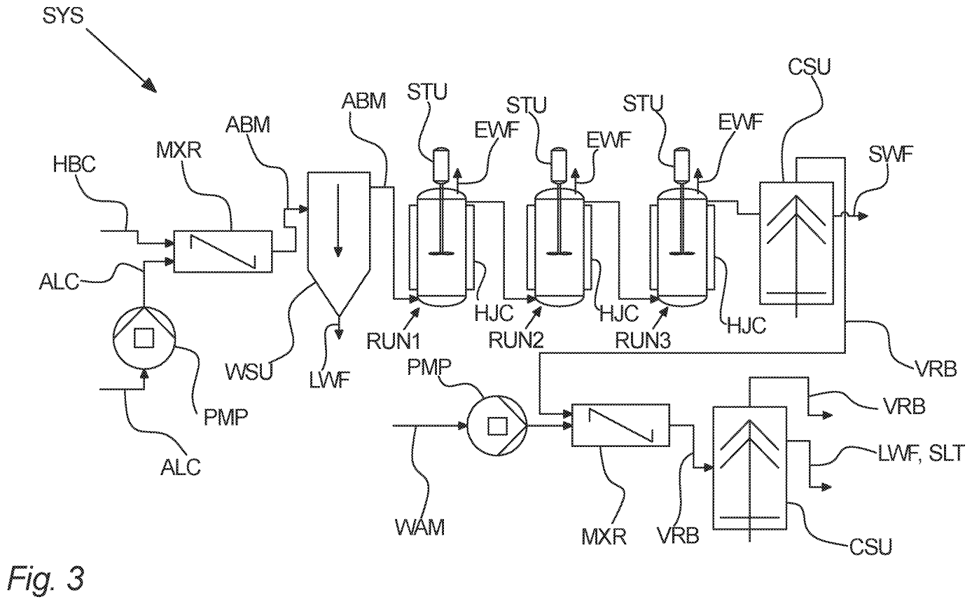

Due to the alcohol biocrude mixture being subjected to the processing temperature of at least the boiling point at the applied processing pressure, at least a part of the alcohol reacts with any carboxylic acids in the HTL based biocrude to form esters. At the same time, any water content already present in the alcohol biocrude mixture and/or resulting from the esterification reaction can be removed as an evaporated water fraction EWF. Depending on the efficiency of the water removal, it may also be desirable to use two or more reactors RUN serially coupled, as illustrated in FIG. 3.

Resulting from the processing of the reactor unit RUN is a viscosity reduced biocrude VRB, where at least some carboxylic acid components have reacted by esterification reaction with the alcohol to form esters, whereby the viscosity of the biocrude is lowered.

The least one alcohol ALC has a boiling point which is above said processing temperature. Thereby, any evaporation of the at least one alcohol ALC is minimized, whereby the at least one alcohol ALC may be keep in the liquid phase together with the HTL based biocrude and its carboxylic acid components with which it is intended to react. Also, any unreacted alcohol may be kept in the liquid phase and thus may be kept in the viscosity reduced biocrude. Having an amount of unreacted alcohol in the viscosity reduced biocrude may typically be acceptable as the alcohol contributes to the heating value of the biocrude.

Turning to FIG. 2, a process for upgrading a hydrothermal liquefaction HTL based biocrude HBC according to a further embodiment is illustrated.

Further to the embodiment of FIG. 1, the process of FIG. 2 shows firstly addition of the at least one alcohol in the hydrothermal liquefaction process and secondly additional water removal by water separation units for liquid-liquid water removal before and after the processing of the alcohol biocrude mixture ABM. Depending on the specific embodiment, these those measures may be implemented independently of each other.

First, the hydrothermal liquefaction HTL is shown as a process, which receives a biomass containing water-based liquid BCS. By subjecting the biomass containing water-based stream BCS to high temperatures and pressure in a hydrothermal liquefaction process, the biomass in the stream BCS to HTL biocrude present in the stream, which then may be labelled the first stream FST. Inside the hydrothermal liquefaction process, e.g. still at the high temperature and pressure associated with the hydrothermal liquefaction process, the at least one alcohol ALC is added to the first stream FST. For example, the at least one alcohol may be added prior to a three-phase separation of the hydrothermal liquefaction HTL.

Second, received alcohol biocrude mixture ABM is subjected to a liquid-liquid separation in a water separation unit WSU in order to remove a liquid water fraction LWF. Thereby, the water content in the alcohol biocrude mixture ABM may be lowered e.g. to about 1-10% water content. The alcohol biocrude mixture ABM is then processed in the reactor unit RUN as described in relation to the embodiment of FIG. 1, whereby an evaporated water fraction is removed. Finally, the resulting viscosity reduced biocrude VRB may be inputted to a second water separation unit WSU to separate an additional liquid water fraction LWF, which may e.g, include solids.

When using liquid-liquid water removal as shown in FIG. 2, or before or water the processing with the processing temperature, the at least one alcohol may preferably have a water solubility 100 gram per Liter at 25 degrees Celsius or lower. Thereby, only minor amounts of alcohol are wasted in the separated liquid water fraction(s) LWF.

Turning now to FIG. 3, a process for upgrading a hydrothermal liquefaction HTL based biocrude HBC according to a further embodiment is illustrated.

Further to the embodiment of FIG. 2, the process illustrated in FIG. 3 comprises several additional steps, which are described below. It is noted that these steps may be incorporated separately in processes of the invention.

First, a pump PMP is shown pumping the at least one alcohol ALC into a mixing unit MXR, to which a HTL based biocrude HBC is also inputted. The resulting alcohol biocrude mixture ABM is then subjected to liquid-liquid water separation in the water separation unit WSM, which may e.g. benefit from polar-nonpolar phase separation between a water based phase and a phase with the biocrude components and alcohol.

The subsequent line of three serially connected reactor units RUN1-RUN3, here illustrated as CSTR reactors units with stirring units STU and heating jackets HJC, then receives the alcohol-biocrude mixture ABM and separates three evaporated water fractions EWF to give a resulting viscosity reduced biocrude VRB.

The viscosity reduced biocrude VRB is then subjected to a second liquid-liquid water separation in a centrifugal separation unit, where a solids and water fraction SWF is removed from the viscosity reduced biocrude VRB.

Then, a water-acid mixture WAM is added by means of a pump PMP and a mixing unit MXR. Alternatively, a clean water fraction may be added instead of the water-acid mixture. In a centrifugal separation unit CSU, a further liquid water fraction LWF comprising salts may then be removed and a final, washed viscosity reduced biocrude VRB is obtained.

### FIGURE REFERENCES

HBC. Hydrothermal liquefaction based biocrude
FST. First stream
ALC. Alcohol
ABM. Alcohol biocrude mixture
EWF. Evaporated water fraction
VRB. Viscosity reduced biocrude
PMP. Pump
MXR. Mixing unit
WSU. Water separation unit
LWF. Liquid water fraction
STU. Stirring unit
RUNi. i'th reactor unit
HJC. Heating jacket
CSU. Centrifugal separation unit
SWF. Solids and water fraction
WAM. Water acid mixture
SLT. Salts

### Examples

A HTL based biocrude was processed in a processing plant as illustrated in FIG. 3. Octanol was applied as the alcohol and added to the biocrude in an amount of 3000 by weight of the resulting alcohol biocrude mixture.

Samples with and without catalyst (sulfuric acid) were made.

Viscosity of the HTL based biocrude, the alcohol biocrude mixture, and resulting viscosity reduced biocrudes was measured with a Brookfield DVNext viscometer equipped with a 20 mm conical plate. All measurements were taken at 40 °C, using 1 s\hat{ }-1 shear rate and 300 μm of gap. The viscosity measurements are shown in table 1 below.

TABLE 1

| | Processing | | | |
|---|---|---|---|---|
| Sample | temperature | | Viscosity | |
| (processing | (degrees | Viscosity | change | |
| time) | Celsius) | (mPa*s) | (%) | Comment |
| Biocrude | N/A | 15000 | 0.0% | Pure biocrude |
| (N/A) | | | | apparent viscosity |
| | | | | with solids |
| | | | | (around 10%) |
| Biocrude + | N/A | 10280 | −31.5% | Biocrude with |
| 30% Octanol | | | | octanol |
| (N/A) | | | | |
| VRBC01 | 110 | 3311 | −77.9% | Final sample after |
| (4 hours) | | | | reaction with |
| | | | | catalyst (1 drop |
| | | | | of H2SO4) |
| VRBC02 | 130 | 3907 | −74.0% | Final sample after |
| (4 hours) | | | | reaction with |
| | | | | catalyst (1 drop |
| | | | | of H2SO4) |
| VRBC03 | 150 | 7036 | −53.1% | Final sample after |
| (4 hours) | | | | reaction with |
| | | | | catalyst (1 drop |
| | | | | of H2SO4) |
| VRBC04 | 110 | 6300 | −58.0% | Final sample after |
| (4 hours) | | | | reaction without |
| | | | | catalyst |
| VRBC05 | 130 | 6586 | −56.1% | Final sample after |
| (4 hours) | | | | reaction without |
| | | | | catalyst |
| VRBC06 | 150 | 7296 | −51.4% | Final sample after |
| (4 hours) | | | | reaction without |
| | | | | catalyst |

As observed in table 1, significant viscosity reductions (compared to the biocrude) were obtained for all processed samples, ranging from 51.4% to 58.0% for samples without catalyst and from 53.1% to 77.9% for samples with sulfuric acid catalyst.

This was significantly more than the viscosity reduction obtained merely by mixing with the octanol alcohol, demonstrating how the esterification achieves significant viscosity reductions.

1-53. (canceled)

54. A process for upgrading a hydrothermal liquefaction (HTL) based biocrude comprising the steps of:
providing a first stream comprising HTL based biocrude,
mixing the HTL based biocrude with at least one C4 or higher alcohol to provide an alcohol-biocrude mixture of which the at least one C4 or higher alcohol is between 3 and 50% by weight, and
processing the alcohol-biocrude mixture in a liquid-liquid water separation unit so as to remove water content,
wherein the at least one C4 or higher alcohol may be a single alcohol or a mixture of two or more alcohols.

55. A process for upgrading a hydrothermal liquefaction (HTL) based biocrude (HBC) comprising the steps of:
providing a first stream comprising HTL based biocrude,
mixing the HTL based biocrude with at least one C4 or higher alcohol to provide an alcohol-biocrude mixture of which the at least one C4 or higher alcohol is between 3 and 50% by weight, and
processing the alcohol-biocrude mixture at a temperature that is at least the boiling point of water at the processing pressure but beneath the boiling point of the at least one C4 or higher alcohol so as to separate an evaporated water fraction and form a viscosity reduced biocrude,
wherein the at least one C4 or higher alcohol may be a single alcohol or a mixture of two or more alcohols.

56. The process of claim 55 in which the heating of the HTL based biocrude and the at least one C4 or higher alcohol to processing temperature is prior to mixing the HTL based biocrude and the at least one C4 or higher alcohol.

57. The process of claim 55 in which the heating of the HTL based biocrude and the at least one C4 or higher alcohol to processing temperature is subsequent to mixing the HTL based biocrude and the at least one C4 or higher alcohol.

58. The process of claim 55 in which acid catalyst is added to the alcohol-biocrude mixture.

59. The process of claim 55 wherein the HTL based biocrude is produced in a hydrothermal liquefaction process which comprises a depressurization step and a three-phase product separation step and wherein the mixing with at least one C4 or higher alcohol step is subsequent to the depressurization step and prior to the three-phase separation step.

60. The process of claim 55 wherein the processing temperature is at least 110 °C.

61. The process of claim 55 wherein the processing temperature is within a range of 120 to 180 °C.

62. The process of claim 55 wherein the reduced viscosity biocrude has a viscosity as measured by a Brookfield DVNext viscometer equipped with a 20 mm conical plate at 40 °C using 1 s-1 shear rate and 300 μm of gap that is at least 40% lower than the HTL based biocrude.

63. The process of claim 55 wherein said processing has a duration between 1 and 24 hours.

64. The process of claim 55 wherein the processing pressure is below 5 bar.

65. The process of claim 55 wherein prior to processing the alcohol-biocrude mixture at a temperature that is at least the boiling point of water, the alcohol-biocrude mixture is processed in a liquid-liquid water separation unit so as to remove water content.

66. The process of claim 55 further comprising the step of processing the viscosity reduced biocrude in a liquid-liquid water separation unit so as to remove water content.

67. The process of claim 65 further comprising mixing the reduced viscosity biocrude with a water-acid mixture and then processing the mixture in a liquid-liquid water separation unit so as to separate and remove a liquid water fraction comprising salts and obtain a washed viscosity reduced biocrude.

68. The process of claim 66 further comprising mixing the reduced viscosity biocrude after removal of water content with a water-acid mixture and then processing the mixture in a liquid-liquid water separation unit so as to separate and remove a liquid water fraction comprising salts and obtain a washed viscosity reduced biocrude.

69. The process of claim 55 further comprising mixing the reduced viscosity biocrude with a water-acid mixture and then processing the mixture in a liquid-liquid water separation unit so as to separate and remove a liquid water fraction comprising salts and obtain a washed viscosity reduced biocrude.

70. The process of claim 55 wherein the at least one C4 or higher alcohol is selected from alcohols having a molar mass between 80 and 220 g/mol.

71. The process of claim 55 wherein the at least one C4 or higher alcohol has a solubility in water at 25 °C no more than 10 g/L.

72. The process of claim 55 wherein the at least one C4 or higher alcohol may be aliphatic alcohols or predominantly aliphatic alcohols.

73. The process of claim 55 wherein the at least one C4 or higher alcohol comprises aliphatic alcohol in an amount of at least 80% by weight of the at least one C4 or higher alcohol.
